(19) United States
(12) Patent Application Publication
(10) Pub. No.: US 2014/0188933 A1
(43) Pub. Date: Jul. 3, 2014

(54) Method for Operating a Field Device

(71) Applicants: Alain Chomik, Pulversheim (FR); Nilolai Fink, Aesch (CH); Elmar Hufschmid, Albbruck (DE)

(72) Inventors: Alain Chomik, Pulversheim (FR); Nilolai Fink, Aesch (CH); Elmar Hufschmid, Albbruck (DE)

(73) Assignee: Endress + Hauser Flowtec AG, Reinach (CH)

(21) Appl. No.: 14/126,528

(22) PCT Filed: May 21, 2012
(86) PCT No.: PCT/EP2012/059358

§ 371 Date: Feb. 5, 2014

(30) Foreign Application Priority Data
Jun. 24, 2011 (DE) 10 2011 078 030.0

(51) Int. Cl. G06F 17/30

(52) U.S. Cl. CPC G06F 17/30864
USPC 707/770

(57) ABSTRACT

A method for operating a field device via a fieldbus system for fieldbus communication with at least one additional field device. A web server a web browser, and a web server communication interface, via which the web browser, and a web server communication is performable. The method includes the steps executed by the field device as follows: receiving a web browser query via the web browser, web server, communication interface concerning at least also information of at least one additional field device; retrieving the queried information from the respective, at least one additional field device via the fieldbus communication connection; incorporating the information obtained from the at least one additional field device into a web page; and providing the web page via the web browser, web server, communication interface.

The present invention relates to a method for operating a field device forming a sensor and/or an actuator and connected via a fieldbus system for communication with at least one additional field device, wherein the first field device has a web server and a communication interface for communication between a web browser and the web server. Furthermore, the present invention relates to a correspondingly embodied field device.

In process automation technology, field devices are often applied, which serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a pipeline section, respectively the fill level in a container, can be changed. A large number of such field devices are produced and sold by the firm, Endress+Hauser. Such field devices are connected in modern industrial plants, as a rule, via fieldbus systems (Profibus®, Foundation@ Fieldbus, HART®, Ethernet with corresponding provisions for the different fieldbusses, etc.) with one or more communication units, which perform, for example, in reference to the field devices associated with them, process control and/or other functions, such as, for example, state or condition monitoring, visualizing, engineering, servicing, archiving, asset or plant management, etc.

Field devices of the newer generation are, as a rule, equipped with a web server, so that they can handle queries of a corresponding communication unit in the context of communication between a web browser and the web server. Especially, a user can apply a simple display device having a web browser to address a particular field device via its URL address (URL: Uniform Resource Locator) in the context of communication between the web browser and the web server, in order to view information of such field device. Furthermore, in newer plants, more and more, PROFINET fieldbusses are being applied (e.g. Ethernet Profibus, Ethernet/IP (Ethernet Industrial Protocol), Ethercat, ModBus-TCP, etc.), so that field devices of the newer generation are also designed for communication according to these protocols.

Moreover, superordinated communication units (with corresponding display units) are known, which are connected for communication with the respective field devices directly or via a gateway and centrally visualize information of a plurality of field devices and/or which centrally provide a user interface, via which parameter settings on a plurality of field devices connected for communication with the superordinated communication unit can be carried out. Such a central, superordinated communication unit is described in EP 1 947 805 A1, wherein such is formed by a central system for inventory management. In such case, communication units are integrated, in each case, into corresponding inventory registering devices. In this way, in each case, via ₜhe Internet, fill level data or pressure data can be transmitted from the inventory registering devices to the central system and open or closed loop control data can be transmitted from the central system to the respective inventory registering devices.

The provision of a central communication unit for visualizing information of a plurality of field devices is associated always with increased costs. Especially, as a rule, such a central communication unit requires corresponding software, in order to allow a user to navigate among, and select, the field devices, for which a visualizing of information is desired, and to query desired information from the respective field devices.

Accordingly, an object of the present invention is to provide a method as well as a correspondingly embodied field device to enable a user in simple, cost effective and flexible manner to retrieve information from the field device and from at least one additional field device connected for fieldbus communication.

The object is achieved by a method as defined in claim 1 for operating a field device forming a sensor and/or an actuator, as well as by a field device as defined in claim 11 forming a sensor and/or an actuator. Advantageous further developments of the invention are set forth in the dependent claims.

The invention provides a method for operating a field device forming a sensor and/or an actuator. The field device is, in such case, connected via a fieldbus system for fieldbus communication with at least one additional field device, includes a web server and includes a web browser, web server, communication interface, via which web browser, web server, communication is performable. The method includes steps as follows executed by the field device:
A) receiving a web browser query via the web browser, web server, communication interface, wherein the web browser query relates at least also to information of at least one additional field device;
B) retrieving the queried information from the respective, at least one additional field device via the fieldbus communication connection;
C) incorporating the information obtained from the at least one additional field device into a web page; and
D) providing the web page via the web browser, web server, communication interface.

Advantageous in the method of the invention is that via web browser, web server, communication with a single field device also information of additional field devices can be provided. To this point in time, it has, indeed, been possible in the case of field devices of the newer generation that a user would apply a simple display device having a web browser to produce a web browser, web server, communication connection with a desired field device by entering its URL address. Then, information relative to such field device could be queried. A combining of the information of a plurality of field devices was, in such case, however, not possible, so that the previous obtaining of information of a plurality of field devices by a user applying such a simple display device having a web browser was time consuming, tiresome and often unclear. Accordingly, the method of the invention permits application of such a simple display device having a web browser to provide an extensive information display for a plurality of field devices comfortably, rapidly and well arranged, since, for this, only the establishing of a web browser, web server, communication connection to a single field device is required. Compared to the application of a central communication unit (for example, a gateway connected to a fieldbus system, a central service unit connected to a fieldbus system or to a superordinated network, etc.) embodied especially for information display of a plurality of field devices, there is, in such case, the advantage that the method of the invention is based on a decentralized construction with distributed intelligence and the advantages associated therewith are utilized. Especially, for the method of the invention, there are no acquisition costs for a central communication unit with corresponding software. Furthermore, a system based on the method of the invention is robust as regards the failure of a device, since in the case of a defect arising in a field device relative to obtaining the information, it is simple to produce a web browser, web server, communication connection to some additional field device within the relevant fieldbus segment. As a result, a user can, by the method of the invention, rapidly obtain an overview of a plurality of field devices. Needed for this is only a simply embodied display device having a web browser (with web browser standard functionality), such as provided, for example, by a laptop, a computer with a monitor, a smart phone, a PDA (personal digital assistant), etc. Furthermore, it is advantageous that field devices of the new generation are, as a rule, designed for web browser, web server, communication and, furthermore, the newer fieldbus protocols are designed to transmit web pages via the fieldbus directly or packaged as data packets in a telegram. Furthermore, it is advantageous that fieldbusses of the newer generation, especially Ethernet based fieldbusses (e.g. Profinet, Ethernet/IP, EtherCAT, ModBus-TCP) have no strict master, slave structure, so that a queried field device can independently initiate a communication and query the respectively required information directly from the respective, additional field devices. The queried field device, which initiates the communication, acts in the context of this retrieval then (temporarily) as a client, while the additional field device acts as a server. Accordingly, the base functionalities for performing the method of the invention are already present in the field devices of the newer generation and it is only necessary to provide a corresponding adapting in the field devices, in order that the method of the invention be performable.

The terminology “field device” in the context of the present invention refers exclusively to a sensor and/or an actuator, not, however, to a gateway, linking devices, etc., which do not act as a sensor or actuator. In the context of the present invention, that field device, to which the web browser query is directed (compare step A)), is referred to as the “queried field device”, especially in order to distinguish such from the at least one additional field device, from which the “queried field device” retrieves (compare step B)). The fieldbus system, via which the queried field device communicates with the at least one additional field device, can have one or more fieldbusses, respectively fieldbus segments. In such case, is, however, provided that the fieldbus communication connection between the queried field device and the at least one additional field device extends exclusively over one or more fieldbusses. The particular fieldbus can, in such case, be embodied by wire and/or wirelessly.

The terminology “web browser” refers to software, by which queries are presentable to a web server and by which web pages are displayable. Such a web browser must have a visualizing program module for graphical representation of web pages. The terminology “web server” refers to software (in the present instance implemented in the queried field device), by which data, especially web pages, are transmissible to a web client (in the present instance formed by a web browser) upon query of the same. The terminology “web browser, web server, communication” refers to communication between a web browser and a web server. Especially, this communication occurs on the application layer of the http- or https protocol (http: hypertext transfer protocol; https: hypertext transfer protocol secure). The transport protocol can in the case of the web browser, web server communication occur, for example, according to TCP/IP. This is, however, not absolutely necessary. For example, it can also be provided that the queried field device communicates directly according to some other transport protocol (e.g. that of the respective fieldbus) and a gateway is provided between the queried field device and the web browser, which performs a corresponding protocol conversion to the TCP/IP protocol for the web browser. This last variant is especially then an option when the web browser, web server, communication extends sectionally via a fieldbus (e.g. Profinet, Ethernet/IP, EtherCAT, ModBus-TCP), for example, when a display device having a web browser is connected via a gateway with the fieldbus, to which also the queried field device is connected.

In general, it can be provided that the web browser, web server, communication occurs via a communication path extending completely separately from the fieldbus communication. In the case of this variant, there are present in the field device both the web browser, web server, communication interface as well as a fieldbus communication interface embodied separately therefrom. The web browser, web server, communication can especially occur via a point to point connection (e.g. via Bluetooth, etc.), via a local network and/or a network limited to certain participants (e.g. LAN (Local Area Network), PAN (Personal Area Network), or also via the “World Wide Web” (WWW). In the case of the different variants, especially in the case of use of a public network, in each case, a limitation of the access authorization can be provided, such as, for example, via a password protected access, etc. and/or also a direct dialing into a certain modem or a certain network node can be performed, so that an increased security level is achieved against unauthorized access. For data transmission in the context of the web browser, web server, communication, basically all wireless or wired variants can be utilized, which support a packet oriented communication of Internet protocols. Especially, the data transmission can occur via ISDN (Integrated Services Digital Network), an analog telephone connection, GSM (Global System for Mobile communications), GPRS (General Packet Radio Service), EDGE (Enhanced Data Rates for GSM Evolution), DSL (Digital Subscriber Line) or other suitable broadband connections. Alternatively to the above explained, separately extending fieldbus communication and web browser, web server, communication, it can also be provided that the web browser, web server, communication occurs, at least sectionally, via the fieldbus, to which the relevant, queried field device is connected, and, accordingly, the web browser, web server, communication interface in the queried field device simultaneously acts as a fieldbus communication interface. For example, this would be the case, when the web browser is connected via a gateway to the relevant fieldbus and the communication via the section between the gateway and the queried field device occurs, in each case, via the fieldbus (e.g. Ethernet/IP, ModBus-TCP, or, in given cases, also Profinet or EtherCAT). Between the gateway and the web browser, especially the variants explained above in reference to the web browser, web server, communication provide options. In general, in the case of fieldbus protocols, which are not http- or https capable, both for the communication between the queried field device and a gateway (compare step A)), via which the queried field device communicates with a web browser, as well as also for the communication between the queried field device and the one or more additional field devices (compare step B)), it can be provided that the respective web pages are transmitted as wanted data (e.g. as an XML file) in a telegram according to the respective fieldbus protocol. The data transmitted in the context of the web browser, web server, communication can especially be present in the HTML format (Hypertext Markup Language), wherein also transmission of Java scripts, Flash based data, etc. provide other options. Especially, any data format can be used, which is suitable for communication according to http or https.

In the case of the step of receiving a web browser query (compare step A)), such involves the web browser's obtaining a web page provided by the web server, such as generally occurs in the context of a web browser, web server, communication for obtaining web pages. In such case, it is preconfigured within the web server, which web pages it can, in each case, display and which information is, in each case, to be incorporated into, respectively represented, in the respective web pages. The user can, such as is the case in the obtaining of web pages in the World Wide Web, click on certain fields on a web page and so display other web pages. Such a clicking on a field, or a link, then generates the web browser query, which the web server recognizes as an order to provide a corresponding web page. In the case of the method of the invention, the web page to be provided in response to the received web browser query (compare step A)) is embodied in such a manner (respectively is so preconfigured in the web server) that it also includes information from at least one additional field device (in given cases, also supplementally to information of the queried field device). In order to then be able to provide this information in the queried web page, the queried field device retrieves the queried information, which concern the at least one additional field device, from the at least one additional field device (compare step B)), in order to incorporate it then into the queried web page (compare step C)) and to transmit to the web browser for presenting the web page (compare providing the web page under step D)). In reference to the step of incorporating (compare step C)), it is to be taken into consideration that the retrieved web page can have information in the form of pure data, web page parts and/or links (respectively references) to web pages of the queried field device or of the at least one additional field device, such as is generally known in the presenting of web pages in the World Wide Web. As can be perceived from the description of the method of the invention, the queried field device must be correspondingly embodied, respectively adapted, for performing the steps of the invention. Correspondingly, also the at least one additional field device, from which the queried information is retrieved (compare step B)), must also be embodied, respectively adapted, for providing and transmitting the respective information.

In the case of the step of retrieving (step B)), basically different variants exist, such as how, respectively in which format, the queried information are transmitted from the at least one additional field device to the queried field device via the fieldbus communication connection. Especially, it can be provided as wanted data, such as, for example, in the form of an XML file (Extensible Markup Language), so that the queried field device can incorporate such directly, or, in given cases, further processed, into the queried web page. The queried information can also be transmitted from the at least one additional field device via the fieldbus communication connection to the queried field device in the form of a web page or as part of a web page, to the extent that the relevant fieldbus permits direct transmission of web pages (e.g. such as is the case for Ethernet/IP and ModBus-TCP). Furthermore, alternatively, also only a link to a web page of the additional field device can be transmitted from the additional field device to the queried field device. In the latter case, incorporated into the web page provided by the queried field device is only the link to the corresponding web page of the additional field device. This latter case assumes, however, that the field devices are connected for communication with one another via an http- or https capable protocol and are in the same fieldbus segment (i.e. not isolated from one another by bridges or firewalls).

To the extent that it is mentioned here that “at least one” of a device, a component, a unit or a method step is provided, this refers to the possibility of providing exactly one or alternatively a plurality of such, even when this is not mentioned explicitly each time.

In a further development, the fieldbus system is at least sectionally formed by an Ethernet based fieldbus. Especially, the communication path between the queried field device and the at least one additional field device, from which the retrieval is taking place (compare step B)), is formed by an Ethernet based fieldbus. Especially, the fieldbus system comprises one or more of the following Ethernet based fieldbusses: Profinet, Ethernet/IP, EtherCAT and/or ModBus-TCP. As explained above, these fieldbusses do not have the strict master, slave structure of the many fieldbusses of older generations, so that the queried field device (compare step A)) (which then temporarily acts as a client) can independently initiate a communication and retrieve the required information directly from the at least one additional field device (which then temporarily acts as a server) (compare step B)). Accordingly, compared to a rigid master, slave structure, a flexible and efficient performance of the retrievals between the field devices is enabled.

In a further development, in the step of incorporating (step C)), information of more than one field device is incorporated by the queried field device into the web page. Depending on the queried web page, which is requested by the web browser query (compare step A)), the queried field device can, in such case, incorporate exclusively information of at least two additional field devices or it can also incorporate information relative to itself and at least one additional field device. The advantage of this further development is that the user, by initiating only one query via the web browser, can obtain information concerning a plurality of field devices, which is advantageous as regards fast, immediate and transparent acquisition of information.

In a further development, the step of incorporating includes processing of the information by the queried field device. A processing of the information includes especially, depending to the queried web page, the performing of calculations with the queried information, a combining of the queried information and/or an evaluation of the queried information, wherein these steps can be performed only with reference to information of a single field device or also with reference to combined information of a plurality of field devices. In this further development, accordingly there can be provided by the queried field device web pages with already processed and, therewith, often information of higher value.

In a further development, the web browser query is placed from a display device, which has a web browser and which is connected for web browser, web server, communication with the queried field device, and the web page provided by the queried field device is presented on a display of the display device. As already explained above, an advantage of the method of the invention is that, for placing the web browser query, no specially embodied device and/or program is required, but, instead, any unit having a web browser and a display or connected with such is suitable. In this way, it is enabled that the user can flexibly with any display device, which has these basic functions, by establishing a web browser, web server, communication connection to a field device of a fieldbus system, obtain a clear presentation of information of a plurality of field devices of this fieldbus system in corresponding web pages, which are preconfigured as regards their content. The display device can be, for example, a laptop, a computer with monitor, a smart phone, a PDA, etc., depending on which type of display device happens to be available to the user. This is possible, since the special functionalities required for performing the method of the invention are preferably provided completely within the respective field device. Especially, the display device includes an interaction unit (e.g. keyboard, keys, mouse, etc.), via which a user can effect settings and/or make selections. Moreover, a display device, from which the web browser query is placed, can include also yet other functions, for example, as regards setting parameters of field devices, monitoring states of field devices, etc.

In a further development, the display device is connected for communication with the fieldbus system and the web browser, web server, communication occurs at least sectionally via the fieldbus system. Especially, the display device can, such as explained above, be connected to the fieldbus system directly or via a gateway. This further development is especially advantageous when the fieldbus system also enables the direct transmission of web pages, such being the case, for example, for Ethernet/IP and ModBus-TCP. In a further development, the web browser, web server, communication interface is embodied in the queried field device separately from a fieldbus communication interface, via which the queried field device is connected to the fieldbus system. As explained above, this further development enables that the web browser, web server, communication is performed via a completely separate communication path than the fieldbus communication.

In general, the web browser, web server, communication connection can also trigger functions in the queried field device and/or in additional field devices. In a further development, also a parameter setting in the queried field device is performable by a user via the web browser, web server, communication connection from a display device having a web browser. Furthermore, it is also an option in the case of corresponding forming of the participating field devices that a user perform via the web browser, web server, communication connection established to the queried field device from a display device having a web browser also a parameter setting in at least one additional field device, which is connected for fieldbus communication with the queried field device. In a further development, the following steps performed by the queried field device are provided:
E) receiving a web browser query via the web browser, web server, communication interface, wherein the web browser query relates at least also to a parameter setting of at least one additional field device; and
F) performing of the parameter setting corresponding to the web browser query by the queried field device in the respective, at least one additional field device via the fieldbus communication connection.

This further development is especially advantageous when the web browser, web server, communication is performed via a completely separate communication path than the fieldbus communication. The steps of receiving a web browser query relative to a parameter setting as well as the performing of the parameter setting (steps E) and F)) can occur, in time, parallel, before or after the steps of receiving, retrieving, incorporating and providing of queried information according to the method of the invention (steps A) to D)). This further development enables, in simple manner, also the performing of a parameter setting of at least one additional field device, without that a web browser, web server, communication connection to this additional field device must be separately produced by the user. An example of such a parameter setting is the resetting of the parameter “totalizer”. A variant for enabling such a parameter setting in at least one additional field device via a web page, which is provided by the queried field device, comprises placing or incorporating in such web page a banner, which is provided from the at least one additional field device and via which a parameter setting of the at least one additional field device is enabled. This type of incorporation of banners is known for placing advertising banners in web pages of the World Wide Web.

In a further development, the method includes steps as follows performed by the queried field device:
G) receiving a web browser query via the web browser, web server, communication interface, wherein the web browser query includes a query relative to the available field devices (which are connected with the queried field device for fieldbus communication); and
H) providing a web page via the web browser, web server, communication interface, wherein the web page has a list, in which at least the field devices are given, for which information is providable by the queried field device.

By providing such a web page by the queried field device and by performing the steps (steps G) and H)) of this further development, a user can rapidly obtain an overview of which field devices the queried field device can provide information for. In such case, as already explained above, it is preconfigured within the web server of the queried field device such that a web page of this type is providable and the information concerning the list are incorporable, respectively presentable, in such web page. The steps of receiving the web browser query concerning available field devices (step G)) and of providing the web page with the list (step H)) are especially performed, in time, before the steps A) to D) of the method of the invention and/or the steps E) and F) of the above explained further development, so that the user can know earlier the information relative to the available field devices. The list provides the user rapidly with an overview, so that the user can decide, for which field devices to obtain information via the queried field device and/or in which field devices to perform parameter settings via the queried field device. The field devices, for which information is providable by the queried field device and which are given in the list, include especially the queried field device as well as additional field devices, which are connected with the queried field device for fieldbus communication and which provide the corresponding service, i.e. especially provide the queried information via the fieldbus communication connection (compare step B)) in response to retrieval by the queried field device. Such a list is also referred to as a “live list”. In it are given especially the serial numbers and/or the tag numbers and/or names assignable by a user of the respectively available field devices, so that unique identifications of the respective field devices are enabled. The tag numbers enable, in such case, a unique identifying of the field devices within the plant, wherein the tag numbers include a designation of the position of the field device within the plant and/or relative to the function of the field device within the plant. Moreover, contained in the list can also be other information for the available field devices or links to web pages, where more extensive information concerning the respective field device is provided.

In a further development, the (in step A)) queried information includes measured values, status information (e.g. BAD, GOOD, etc.), diagnostic information and/or alarm states of at least one field device. With reference to this information, then, such as explained above, based on the method of the invention, the steps of retrieving (step B)), incorporating (step C)) and providing (step D)) are performed.

The present invention relates, furthermore, to a field device forming a sensor and/or an actuator, wherein the field device includes a web server, a fieldbus communication interface for connecting to a fieldbus system and, embodied separately from or integrally with the fieldbus communication interface, a web browser, web server, communication interface. A web browser, web server, communication is performable via the web browser, web server, communication interface. The field device is embodied in such a manner that in use—after receipt of a web browser query via the web browser, web server, communication interface concerning at least also information of at least one additional field device connected during use to the same fieldbus system—it can perform a retrieval of the queried information from the respective, at least one additional field device via the fieldbus communication interface in the context of a fieldbus communication, that it can incorporate the information obtained from the at least one additional field device into a web page and that it can provide the web page via the web browser, web server, communication interface. The field device of the invention achieves essentially the same advantages explained with reference to the method of the invention. Furthermore, the above explained further developments and variants are implementable in the case of the field device of the invention in corresponding manner, wherein in the case of method steps especially, to the extent that this makes technical sense, an electronics of the field device is embodied, respectively adapted, for performing the respective method steps.

Other advantages and utilities of the invention will become evident based on the following description of examples of embodiments with reference to the appended drawing, the figures of which show as follows:

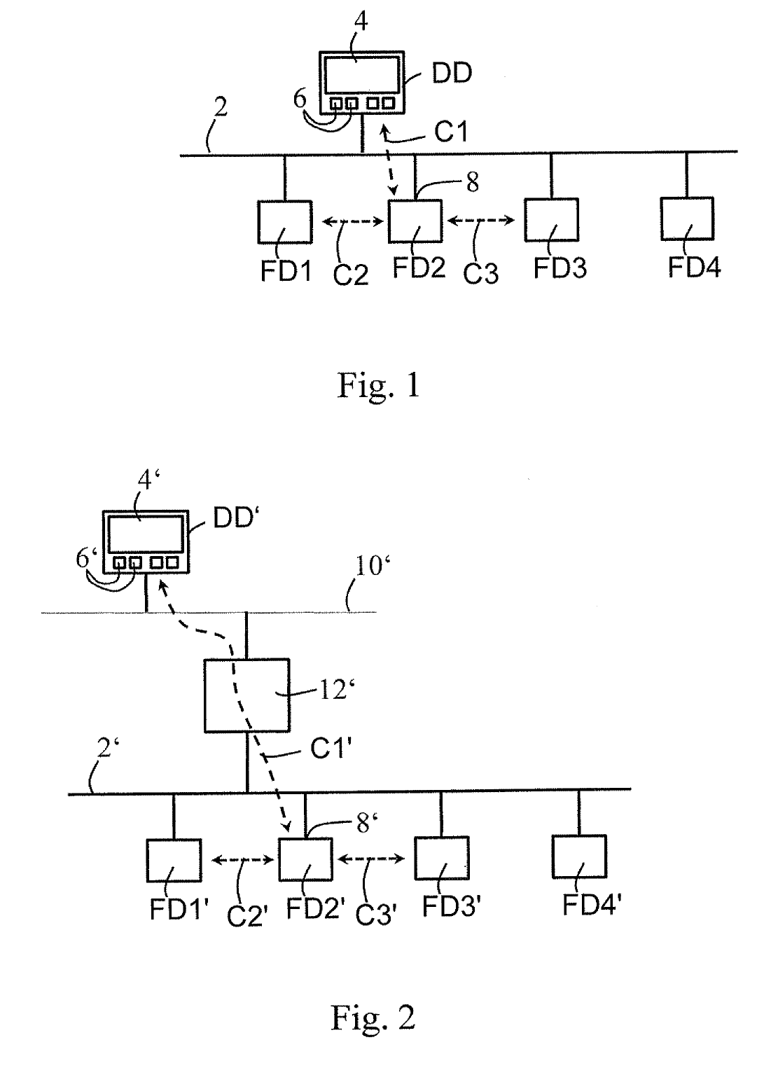

FIG. 1 for illustrating a first form of embodiment of the present invention, a schematic representation of a fieldbus system including a plurality of field devices;

FIG. 2 for illustrating a second form of embodiment of the present invention, a schematic representation of a second fieldbus system including a plurality of field devices; and

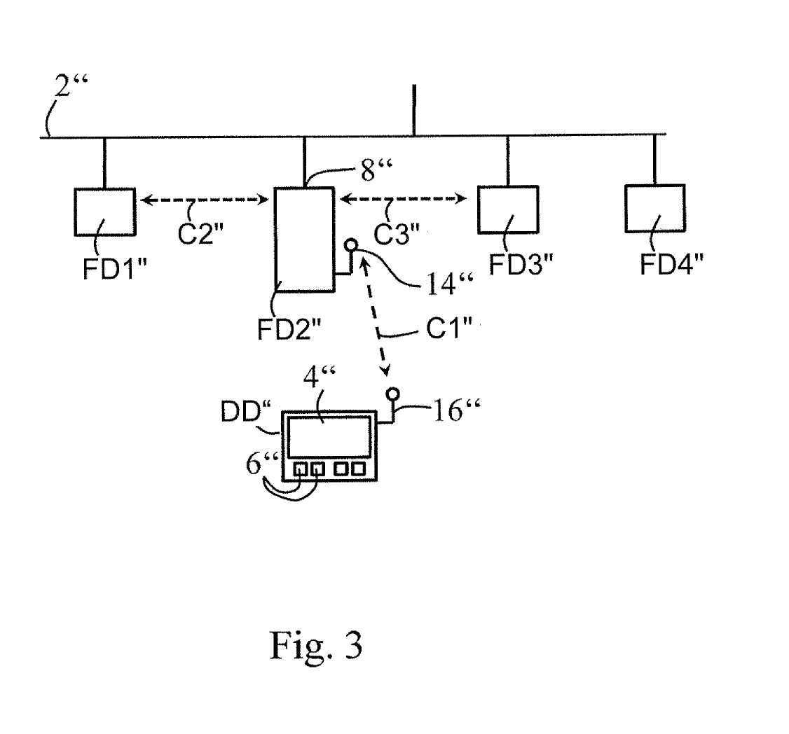

FIG. 3 for illustrating a third form of embodiment of the present invention, a schematic representation of a third fieldbus system including a plurality of field devices.

FIG. 1 shows a fieldbus system 2 formed by a fieldbus segment of an Ethernet/IP fieldbus. Connected to the fieldbus system 2 are four field devices FD1, FD2, FD3 and FD4. Furthermore, a display device DO is connected directly to the fieldbus system 2. The display device DD includes a display 4 as well as interaction elements 6. Implemented in the display device DD is a web browser. Field device FD2 includes an Ethernet/IP communication interface 8 for connecting to an Ethernet/IP fieldbus. This Ethernet/IP communication interface 8 is both a web browser, web server, communication interface as well as a fieldbus communication interface and includes the functions explained above in the Summary of the specification. Moreover, yet other devices, networks, fieldbusses, etc. can also be connected to the fieldbus system 2, such as is indicated by its open ends.

Field device FD2 is connected via the fieldbus system 2 for fieldbus communication with the additional field devices FD1, FD3 and FD4. Field device FD2 includes a web server. A user, who would like to display information of field device FD2 and, in given cases, additional, field devices connected to the fieldbus system 2, can establish via the display device DD a web browser, web server, communication connection C1 to the (queried) field device FD2. First, the user can be provided by the (queried) field device FD2 in a corresponding web page a list, in which the field devices are given, for which information is providable by the queried field device FD2. To this end, the user selects a corresponding web page provided for selection by the field device FD2 (e.g. by clicking a button on the display 4), so that a corresponding web browser query is sent to the queried field device FD2. The queried field device FD2 then provides the list in the selected web page. Present in the list are the tag numbers and serial numbers of the field devices FD1, FD2, FD3 and FD4.

The user can decide that it would like to see status information and measured values of the additional field devices FD1 and FD3. For this, it selects a corresponding web page provided by the queried field device FD2 for selection (e.g. by clicking a button on the display 4, so that a corresponding web browser query is sent to the queried field device FD2. In the context of a fieldbus communication via the fieldbus system 2, the queried field device FD2 retrieves the requested information from the additional field devices FD1 and FD3, this being indicated schematically in Fig. I by the arrows C2 and C3. In the context of this retrieval, the queried field device FD2 is a client, while each of the additional field devices FD1 and FD3 is a server. The queried field device FD2 incorporates the information obtained from the two additional field devices FD1 and FD3 in the context of this retrieval into the web page and provides the resulting web page to the display device DD via the web browser, web server, communication connection C1. In such case, it can also be provided that the queried field device FD2 further processes the information obtained from the additional field devices FD1 and FD3, especially by combining the information from the two additional field devices with one another and/or with information of the queried field device FD2. Furthermore, there is the opportunity that in corresponding manner, also via the field device FD2, parameter settings can be performed on the one or more additional field device(s) FD1 and/or FD3, such as explained in the Summary of the specification.

In the case of the form of embodiment illustrated in FIG. 1 and explained above, the web browser, web server, communication and the fieldbus communication each occur completely via the fieldbus system 2. Accordingly, at the queried field device FD2, the web browser, web server, communication interface and the fieldbus communication interface are formed by one and the same Ethernet/IP communication interface 8 and the display device DD, which likewise has an Ethernet/IP communication interface, is connected directly to the fieldbus system 2.

In the following, other forms of embodiment will now be explained with reference to FIGS. 2 and 3, wherein primarily the differences compared with the first form of embodiment will be explored. To the extent that such makes sense, equal reference characters are used for equal or corresponding components, wherein, to distinguish, in the second form of embodiment, in each case, a prime is applied to the reference character and in the third form of embodiment, in each case, a double prime.

In the case of the second form of embodiment illustrated in FIG. 2, the display device DD' is connected to a superordinated network 10′, which, in turn, is connected via a gateway 12′ to the fieldbus system 2′. The fieldbus system 2′ is embodied corresponding to the first form of embodiment and the field devices FD1′, FD2′, FD3′ and FD4′ are connected directly to it. Yet other devices, networks, fieldbusses, etc. can be connected to the superordinated network 10′ as well as also to the fieldbus system 2′, this being again indicated by the open ends. Correspondingly, same as in the case of the first form of embodiment, a user, who would like to display information of the field device FD2′ and, in given cases, of additional, field devices connected to the fieldbus system 2′, can establish via the display device DD′ a web browser, web server, communication connection C1′ to the (queried) field device FD2′. In contrast to the first form of embodiment, the communication path of the web browser, web server, communication connection C1′ extends via the gateway 12′. The communication path extends especially, on the one hand, via the superordinated network 10′ as well as, on the other hand, via the fieldbus system 2′. The fieldbus communication between the queried field device FD2′ and the additional field devices FD1′ and FD3′ (compare C2′ and C3′ in FIG. 2) extends completely via the fieldbus system 2′. Accordingly, in the case of the second form of embodiment, the web browser, web server, communication interface and the fieldbus communication interface in the case of the queried field device FD2′ are formed by one and the same Ethernet/1P communication interface 8′. The display device 6′ includes a communication interface for connecting to the superordinated (in this case, wired) network 10′. It does not absolutely have to be an Ethernet/IP communication interface. The gateway 12′ performs the required protocol conversion between the superordinated network 10′ and the fieldbus system 2′. This is especially required in the context of the web browser, web server, communication.

In the case of the third form of embodiment illustrated in FIG. 3, the fieldbus system 2″ is embodied corresponding to the fieldbus system 2 of the first form of embodiment. Connected to the fieldbus system 2″ are four field devices FD1′″, FD2′″, FD3′″ and FD4′″. Additionally, yet other devices, networks, fieldbusses, etc. can also be connected to the fieldbus system 2″, such being indicated by the open ends. The (queried) field device FD2″ as well as the display device DD″ each have a Bluetooth® communication interface 14″ (in the case of the field device FD2′″) and 16″ (in the case of the display device DD″), such being indicated in Fig. schematically by corresponding antennas. Accordingly, in the case of the third form of embodiment, a web browser, web server, communication connection C1″ can be established wirelessly via Bluetooth® (between the web browser of the display device DD″ and the web server of the queried field device FD2″). Correspondingly, such as in the case of the first form of embodiment, a user, who would like to display information of the field device FD2″ and, in given cases, additional, field devices connected to the fieldbus system 2″, can, via the display device DD″, establish a web browser, web server, communication connection C1″ to the (queried) field device FD2″. In contrast to the first form of embodiment, the communication path of the web browser, web server, communication connection C1″ extends completely separately from the fieldbus system 2″. The fieldbus communication between the queried field device FD2″ and the additional field devices FD1″ and FD3″ (compare C2″ and C3″ in FIG. 3) extends completely via the fieldbus system 2″. Accordingly, in contrast with the first form of embodiment, in the case of the queried field device FD2″, the web browser, web server, communication interface is formed by the Bluetooth communication interface 14″, and the fieldbus communication interface 8″, which is formed by the Ethernet/IP communication interface 8″, is embodied separately therefrom. The display device 6″, in such case, does not have to have an Ethernet/IP communication interface.

1-11. (canceled)

12. A method for operating a field device forming a sensor and/or an actuator, which is connected via a fieldbus system for fieldbus communication with at least one additional field device, includes a web server, a web browser, and a web server, communication interface, via which the web browser, web server, communication is performable, the method comprises the steps executed by the field device as follows:
receiving a web browser query via the web browser, web server, communication interface concerning at least also information of at least one additional field device;
retrieving the queried information from the respective, at least one additional field device via the fieldbus communication connection;
incorporating the information obtained from the at least one additional field device into a web page; and
providing the web page via the web browser, web server, communication interface.

13. The method as claimed in claim 12, wherein:
the fieldbus system is at least sectionally formed by an Ethernet based fieldbus.

14. The method as claimed in claim 12, wherein:
in the step of incorporating, information of more than one field device is incorporated by the queried field device into the web page.

15. The method as claimed in claim 12, wherein:
the step of incorporating includes a processing of information by the queried field device.

16. The method as claimed in claim 12, wherein:
the web browser query is placed from a display device, which has a web browser and which is connected for web browser, web server, communication with the queried field device; and
the web page provided by the queried field device is presented on a display of the display device.

17. The method as claimed in claim 16, wherein:
display device is connected for communication with the fieldbus system and the web browser, web server, communication occurs at least sectionally via the fieldbus system.

18. The method as claimed in claim 12, wherein:
the web browser, web server, communication interface is embodied in the queried field device separately from a fieldbus communication interface, via which the queried field device is connected to the fieldbus system.

19. The method as claimed in claim 12, wherein:
further steps are performed by the queried field device as follows:
receiving a web browser query via the web browser, web server, communication interface concerning at least also a parameter setting of at least one additional field device; and
performing of the parameter setting corresponding to the web browser query by the queried field device in the respective, at least one additional field device via the fieldbus communication connection.

20. The method as claimed in claim 12, wherein:
further steps are performed by the queried field device as follows:
receiving a web browser query via the web browser, web server, communication interface concerning available field devices; and
providing a web page via the web browser, web server, communication interface, wherein the web page has a list, in which at least the field devices are given, for which information is providable by the queried field device.

21. The method as claimed in claim 12, wherein:
the queried information includes measured values, status information, diagnostic information and/or alarm states of at least one field device.

22. A field device forming a sensor and/or an actuator, wherein the field device comprises:
a web server;
a fieldbus communication interface for connecting to a fieldbus system and, embodied separately from or integrally with the fieldbus communication interface; and
a web browser, web server, communication interface, wherein a web browser, web server, communication is performable via the web browser, web server, communication interface, wherein:
the field device is embodied in such a manner that in use—after receipt of a web browser query via the web browser, web server, communication interface concerning at least also information of at least one additional field device connected during use to the same fieldbus system it can perform a retrieval of the queried information from the respective, at least one additional field device via the fieldbus communication interface in the context of a fieldbus communication, that it can incorporate the information obtained from said at least one additional field device into a web page; and
it can provide the web page via the web browser, web server, communication interface.
